(19) United States
(12) Patent Application Publication
(10) Pub. No.: US 2016/0105097 A1
(43) Pub. Date: Apr. 14, 2016

(54) ELECTRIC ACTUATOR SYSTEM

(71) Applicant: LINAK A/S, Nordborg (DK)

(72) Inventor: Henning KRISTENSEN, Sydals (DK)

(73) Assignee: LINAK A/S, Nordborg (DK)

(21) Appl. No.: 14/890,611

(22) PCT Filed: May 12, 2014
(86) PCT No.: PCT/DK2014/000026

§ 371 Date: Nov. 12, 2015

(30) Foreign Application Priority Data
May 13, 2013 (DK) PA201300286

(51) Int. Cl. H02M 1/44; H02M 1/14; H02M 7/06

(52) U.S. Cl. CPC H02M 1/44; H02M 7/06; H02M 1/14

(57) ABSTRACT

An actuator system having at least one electrical linear actuator, wherein the actuator system comprises a controller and a power supply, wherein the noise reduction of common-mode noise in the input stage to the switch-mode converter is undertaken on the rectified and smoothed supply voltage.

The invention relates to an actuator system comprising a linear actuator, a controller, a power supply and an operating unit.

Actuator systems with electrically driven linear actuators are widely used within the field of adjustable furniture, such as e.g. adjustable tables, adjustable beds and chairs. Electrically driven linear actuators are also used in numerous other industrial products, wherein an electrically driven linear actuator is advantageously integrated into a mechanical structure for the adjustment of a mechanically movable component. Linear actuators comprising a piston rod, for example of the type described in WO 02/29284 A1 Linak A/S, are well suited for the task. This type of linear actuator comprises a spindle having a spindle nut. The spindle is driven by a reversible electric motor via a transmission. When the spindle is driven, the spindle nut is moved in an inward or outward direction depending on the direction of rotation of the electric motor. The linear actuator is a separate product, wherein the spindle, transmission and electric motor are enclosed within a housing. The housing typically consists of a motor housing and an outer tube. An inner tube is secured to the spindle nut. The inner tube is displaced in and out of the outer tube concurrently with the movement of the spindle nut in and out on the spindle. Linear actuators may also be designed as lifting columns, as described in WO2004/100632 A1 to Linak A/S.

The actuator system is usually supplied from mains via a converter, which is adapted to convert the alternating voltage from the mains to a direct voltage at a suitable voltage level. Converters based on transformers have been used for decades, but recent years' focus on energy-efficient converters and low standby power consumption has directed the attention more and more towards the use of switch-mode power supplies, which has obvious advantages both with regard to lower conversion losses, but also in that the construction is more compact and therefore does not take up as much space. However, switch-mode power supplies are more expensive to manufacture and also have the disadvantage that, owing to their mode of operation, whereby they switch the converted power in small packets, they can generate electrical noise which can be disturbing to other electronics connected to mains. The DC motor of the actuator also contributes to the noise, as the commutator likewise switches the current for the armature winding. It is therefore a legal requirement to effectively prevent this electrical noise from propagating back on the mains. Since the noise to be reduced is within the frequency range of 150 kHz to 30 MHz, this is ensured by designing a suitable low-pass filter at the input of the switch-mode supply. This puts demands on the power supply which should still be able to draw the necessary power from the mains.

There is also a particular focus on reduction of common-mode noise, i.e. noise which occurs on both input leads with reference to ground. Common-mode noise is reduced by introducing self-inductance in both input leads; said self-inductances are to the same core. Thus, the noise balances itself out electromagnetically in the coil and thus does not propagate to the mains. Further, the common-mode coil has good damping means for unbalanced noise. The drawback is that common-mode coils are expensive and relatively bulky, for which reason a solution to the problem of reduction or elimination of common-mode noise in the input stage of a switch-mode power supply is desired, which is less expensive and is more compact.

To comprehend the invention, it is relevant to study the conventional method of constructing a common-mode filter on and positioning of the filter in the power supply.

The input stage of a power supply may be divided into blocks, each with its own function: a first block for connection to the mains, with a capacitor which removes high-frequency noise; a further block consisting of the common-mode filter; a third block with the rectifier circuit, and a last block with a capacitor for noise reduction and ripple reduction of the direct-current voltage.

Connection to the alternating voltage of the mains is realized via a fuse located in series on one of the input leads. In order to limit the peak current upon connection to the mains, an NTC resistor has also been introduced in series with the input lead. Subsequently, a capacitor is inserted in parallel across the input leads. In accordance with the state of the art, the common-mode filter with the two windings is inserted at this location in such a way that each of the two input leads is led through a separate individual self-inductance on a common core. The supply is led from the other side of the self-inductances in the common-mode filter, on to a bridge rectifier for rectification of the alternating voltage. A capacitor connected on the output voltage from the bridge rectifier smooths the voltage for further supply into the switch-mode converter.

A quick calculation of voltages and currents within the circuit reveals that the voltage downstream of the bridge rectifier is square root of two times higher than the input voltage. In the same way, the current on the output side is square root of two times lower than on the input side. In other words, the product VA, which describes the electrical power, is the same on the input side of the stage as on the output side of the stage. The loss within the stage is minimal and can therefore be ignored.

However, the physical size of the common-mode coil is dependent upon the current flowing through the coil, the size increasing proportionally to the square of the current.

Taking these discoveries into consideration, and with the intention of resolving the problem outlined, wherein in the context of designing a switch-mode power supply for an actuator system, and especially in the context of the reduction of common-mode noise in the input stage, a solution is required which is more inexpensive and compact, this is achieved according to the invention in that the common-mode filter is positioned within the input stage.

The power supply for an actuator system consists of a rectifier circuit for rectifying an alternating voltage to a direct voltage, a common-mode filter for reducing common-mode noise, and a switch-mode converter for regulating a direct voltage, wherein the common-mode filter is inserted into the power supply between the rectifier circuit and the switch-mode converter.

More specifically, filtering of common-mode noise is performed via the rectified voltage supply of the power supply.

Furthermore, the alternating voltage input of the power supply is provided with a capacitor for noise reduction.

The rectified voltage supply of the power supply is provided with a capacitor for noise reduction and direct-voltage ripple reduction.

The power supply is successively constructed from:
a first block for connection to the mains, with a capacitor for noise reduction
a second block with a rectifier circuit,
a third block with a capacitor for noise reduction and direct-voltage ripple reduction, followed by
a fourth block consisting of the common-mode filter and
a fifth block having a switch-mode converter for regulating a direct voltage.

Connection to supply of the switch-mode converter is thus undertaken within the fourth block.

The invention further relates to an actuator system comprising a least one linear actuator, a controller, an operating unit, and a power supply as described above.

In greater detail, the input stage of the power supply is constructed so that the connection to the alternating voltage of the mains is realized via a fuse applied in series on one of the input leads. In order to limit the peak current upon connection to the mains, an NTC resistor has further been inserted in series with the input lead. Subsequently, a capacitor is inserted in parallel across the input leads. The input leads are connected to a rectifier circuit for rectification of the alternating voltage. A capacitor is connected on the output voltage from the rectifier, and smooths the voltage, downstream of which the common mode filter with the two input leads is connected. Through separate self-inductances on a common core, the input leads form a connection to output terminals of the common-mode filter, advantageously connected to the switch-mode converter. This construction has great advantages, in that the current in the common-mode filter is reduced by a factor of the square root of two relative to a positioning on the alternating voltage side of the input stage. Since the size of the common-mode coil increases by the square of the current, with the instructions according to the invention the physical size of a common-mode coil is reduced to approximately the half whilst still maintaining the same reduction of the common-mode noise according to the prior art. If the circuit is constructed with a doubling of the voltage (instead of the bridge rectification), the size of a common-mode coil can be reduced by a factor of approximately four by following the instructions according to the invention.

To summarize, the input stage is characterized in that the filtering of common-mode noise is realized on the rectified and smoothed voltage supply in the input stage.

With the use of the invention the outlined problem has been resolved by providing a solution which allows for construction of a more compact filter that nevertheless has the same reducing effect of common-mode noise. The reduced requirement for space also makes it possible to construct a common-mode filter having a greater reduction of common-mode noise without taking up more space. There is thus a sizeable economic incitement in being able to choose a smaller common-mode coil, which is cheaper and takes up less space within the power supply or controller cabinet.

It is therefore up to the designer of the common-mode filter to follow the instructions according to the invention and select a suitable compromise which meets the specific requirements for common-mode reduction.

An input stage for a switch-mode supply intended for driving an actuator system with electrical linear actuators according to the invention will be described in greater detail in the following with reference to the accompanying drawings, wherein:

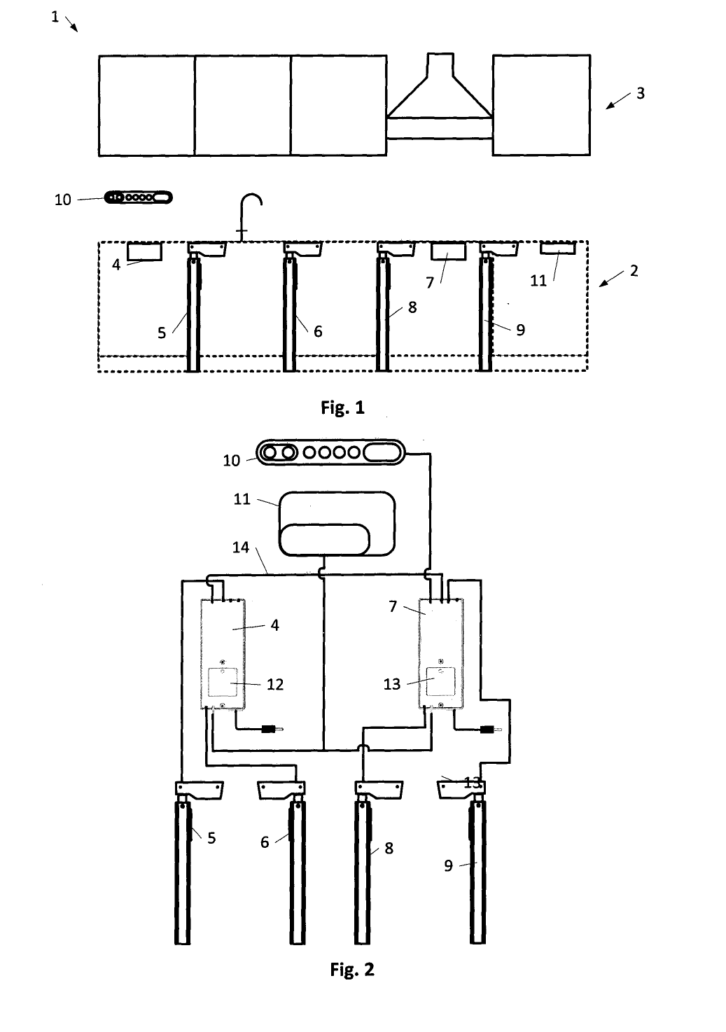

FIG. 1 shows a kitchen arrangement with an inbuilt actuator system for height adjustment of a joined base section of a kitchen arrangement,

FIG. 2: shows a schematic view of the actuator system shown in FIG. 1,

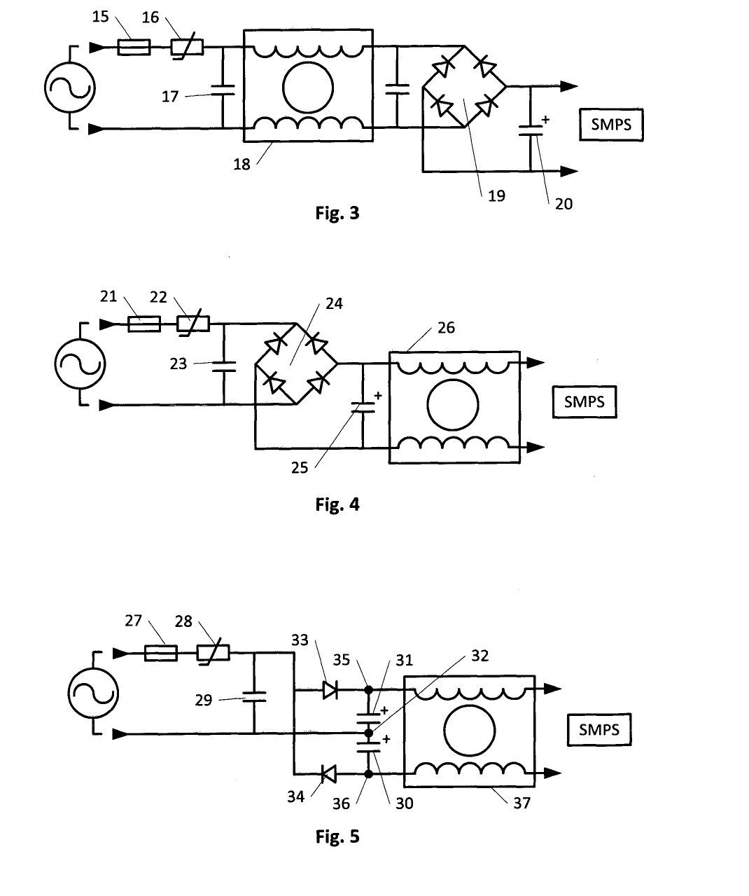

FIG. 3: shows a principal diagram of the prior-art construction of a common-mode filter for a switch-mode power supply,

FIG. 4: shows a principal diagram of the construction of a common-mode filter for a switch-mode power supply according to the invention,

FIG. 5: shows a principal diagram of the construction of an alternative common-mode filter for a switch-mode power supply according to the invention,

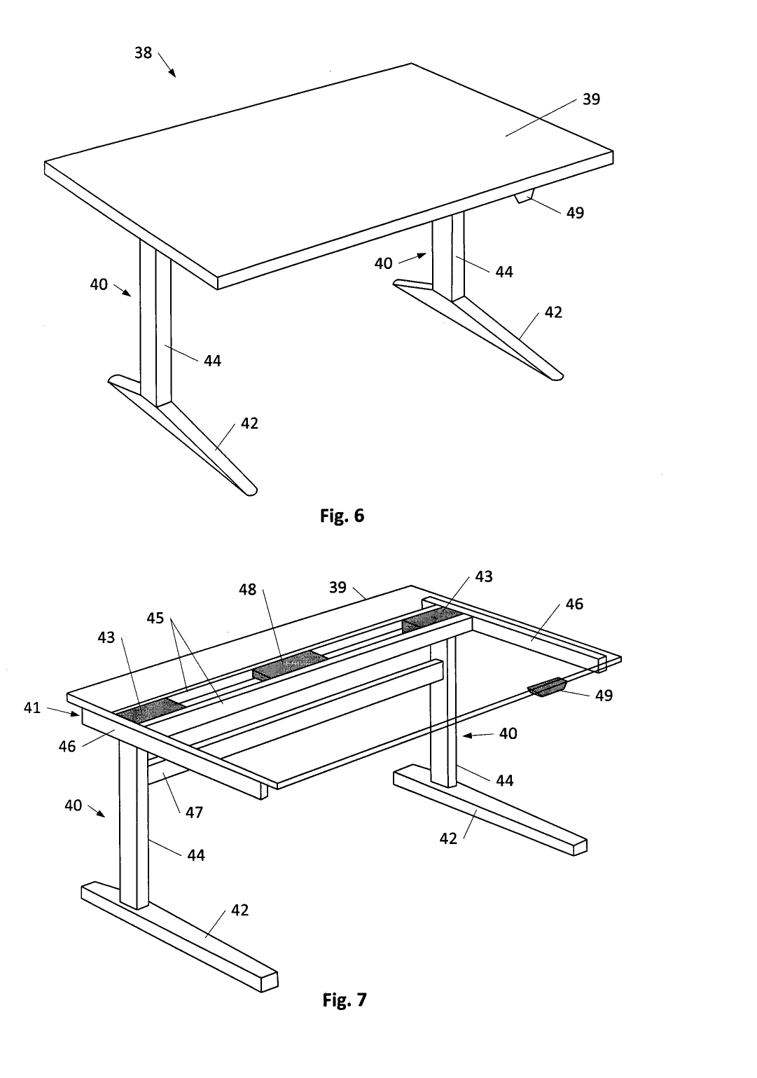

FIG. 6: shows a perspective view of a height-adjustable table, and,

FIG. 7: shows the height-adjustable table shown n with a transparent tabletop.

FIG. 1 of the drawings shows a kitchen arrangement 1 consisting of a base section 2 and an upper section 3. The base section 2 consists of five joined kitchen elements. In the base section 2, the kitchen arrangement 1 is provided with two actuator systems, each consisting of a controller 4,7 and two columns 5,6,8,9, each of which comprises at least one electrical linear actuator. The controller is operated by means of an operating unit 10, which may be wired or wireless. To ensure extra power in peak loads and for emergency lowering, the kitchen section also includes a chargeable battery pack 11.

The construction of the actuator system for the kitchen arrangement shown in FIGS. 1 and 2 is also shown in FIG. 2, which depicts the two controllers 4,7 each with its own in-built power supply 12,13 intended for connection to the mains. The four actuators 5,6,8,9 are connected in pairs to a controller 4,7 each. The operating unit 10 is connected to one of the controllers 7 but controls both actuator systems via a connection to a communications bus 14.

The power supply 12,13 is constructed with an input stage having a rectifier circuit which rectifies and regulates the alternating voltage of the mains before this is fed into a switch-mode converter that regulates and stabilizes the supply voltage to the controller of the actuator system and the drive voltage to actuators etc. Thus, a power supply 12,13 is achieved, which is energy-efficient and reliable, and which at the same time can be made very compact.

FIG. 3 of the drawings shows a principal diagram of the prior-art construction of a common-mode filter for a switch-mode power supply. The connection to the mains is realized via a fuse 15 applied in series on one of the input leads. In order to limit the peak current upon connection to the mains, an NTC resistor 16 has furthermore been inserted in series with the input leads. Downstream of this, a capacitor 17 is inserted in parallel across the input leads. In accordance with the state of the art, the common-mode filter 18 with the two windings is inserted in this location in such a way that each of the two input leads is led through a separate self-inductance on a common core. The magnetic coupling between the coils means that the common-mode noise is effectively decoupled. In general, the coil should be designed with due respect for the core not going in saturated, but still able to compensate for the common-mode noise. This is a general choice of core size and material. Furthermore, the coil winding based on the core should be designed with a view to achieving adequate self-inductance relative to the resistance of the winding. The supply is fed from the other side of the self-inductances in the common mode filter, further to a bridge rectifier 19 for rectification of the alternating voltage. A capacitor 20 connected on the output voltage from the bridge rectifier 19 smooths the voltage for further supply into the switch-mode converter.

According to the invention as shown in FIG. 4, which illustrates a principal diagram for constructing a common-mode filter for a switch-mode power supply, the input stage in the power supply is constructed in the same way as in the prior art, such that the connection to the alternating voltage of the mains is realized via a fuse 21 applied in series on one of the input leads. The NTC resistor 22 in series with the input lead is also retained and so is the capacitor 23, inserted in parallel across the input leads. Unlike the state-of-the-art circuit, the input leads are led further to the rectifier circuit for rectification of the alternating voltage, here constructed with a bridge rectifier 24. A capacitor 25 is applied across the output voltage from the bridge rectifier 24 for smoothing of the voltage. Only after this, the common mode filter 26 is connected to the two input leads on the direct voltage side of the rectifier circuit. Through separate self-inductances on a common core the input leads form a connection to the output terminals of the common-mode filter, which can be connected to the switch-mode converter. This construction yields great advantages, in that the current in the common-mode filter 26 is square root of two times lower relative to a position on the alternating voltage side of the input stage. As the coil size of the common-mode filter increases by the square of the current, a common-mode coil is achieved which is approximately half the physical size but still has the same reduction of the common-mode noise. This can be illustrated with the following example, wherein the supply voltage of the mains is 230V alternating voltage. With a load of one ampere on the mains, the power dissipation is 230 W. Downstream of the rectifier circuit, the voltage is 325V and the current is reduced to 700 mA, which is also 230 W. The reduction of the physical size of the coil may be calculated as follows:

0.7×0.7≈0.5

By comparison with the prior art, the physical size of the coil is therefore reduced by half.

An alternative solution is shown in FIG. 5, which also shows a principal diagram for constructing a common-mode filter for a switch-mode power supply according to the invention. The solution is especially adapted for use for connection to the mains installations with 120V alternating voltage. The connection to the mains alternating voltage is realized via a fuse 27 applied in series on one of the input leads. An NTC resistor 28 is inserted in series with the input leads, and a capacitor 29 is inserted in parallel across the input leads. One of the input leads is led further to a center point between two capacitors 30, 31, which smooths the output voltage. The center point acts as an artificial ground 32. The other input lead is led further to the rectifier circuit for rectification of the alternating voltage, here using two discrete rectifiers 33, 34. The two rectifiers 33,34 conduct their respective half wave of the alternating voltage to the other terminal of the capacitors 30,31, which thus acts as a positive 35 and a negative 36 supply relative to the artificial ground 32. Thus, an output voltage-doubling is achieved. Hereafter, the common-mode filter 37 on the direct voltage side of the rectifier circuit is connected to the two input leads. Through separate self-inductances on a common core the input leads form a connection to the output terminals of the common-mode filter, which may be connected to the switch-mode converter. It is noted that, with this construction, a reduction in the physical size of the common-mode filter by a factor of four can be achieved. This may be illustrated with an example, wherein the supply voltage of the mains is 120V AC. With a load of two amperes on the mains, the power dissipation is 240 W. Downstream of the rectifier circuit, the voltage is 340 V and the current is reduced to 700 mA, which is also 240 W. The reduction in the physical size of the coil may be calculated using the following formula:

$$\frac{0 , 7}{2} \times 0 , 7 \approx 0 , 25$$

By comparison with the prior art, the physical size of the coil is therefore reduced to a fourth.

FIG. 6 is a perspective view of a height-adjustable table 38 comprising a tabletop 39. At each side of the tabletop 39, a linear actuator is mounted in the form of a lifting column 40, e.g. of the type mentioned in WO2004/100632 A1 to Linak A/S. The lifting column is mounted within a supporting frame 41 (see FIG. 7) on which the tabletop 39 is mounted. The other end of each lifting column 40 comprises a foot 42 on which the height-adjustable table stands. The lifting columns 40 comprise a motor housing 43 (see FIG. 7) and two mutually telescopic profiles. One of the profiles 44 is secured to the foot 42 in a stationary position, and the other profile may be displaced telescopically in and out of the stationary profile 44. The displaceable profile is moved by means of an electric motor which drives a spindle via a gear. The spindle is fitted with a spindle nut secured to the telescopically movable member. The displacement of the tabletop 39 is thus determined by the movable profile.

FIG. 7 illustrates the height-adjustable table 38 seen in a perspective view, wherein the tabletop 39 is depicted as transparent. The supporting frame 41, on which the tabletop 39 is mounted, comprises two parallel longitudinal members 45 and two parallel transverse members 46. The two lifting columns 40 are here mutually connected to a cross member 47 in order to increase the stability of the height-adjustable table 39. It is desired to mount the motor housing 43 and the control box of the lifting columns within the dimensions, i.e. length, width and height, given by these longitudinal members 45 and transverse members 46. The control box 48 comprises a controller and a power supply. The latter is of the type described in FIGS. 3-5. The height-adjustable table 38 may be adjusted via the operating unit 49. Accordingly, the height-adjustable table 38 comprises an actuator system comprising two linear actuators in the form of lifting columns 40, a controller, a power supply, and an operating unit.

1. A power supply for an actuator system comprising:
a rectifier circuit for rectifying an alternating voltage to a direct voltage,
a capacitor applied across the output voltages from the rectifier circuit for smoothing of the voltage,
a common-mode filter for reducing common-mode noise, and
a switch-mode converter for regulating a direct voltage,
characterised in that the common-mode filter is inserted into the power supply downstream of the rectifier circuit and the capacitor, and upstream of the switch-mode converter.

2. A power supply for an actuator system according to claim 1, characterized in that the filtering of common-mode noise is realized on the rectified and smoothed voltage supply of the power supply.

3. A power supply for an actuator system according to claim 1, characterized in that the alternating voltage connection of the power supply is provided with a capacitor for noise reduction.

4. A power supply for an actuator system according to claim 1, characterized in that the rectified voltage supply of the power supply is provided with a capacitor for noise reduction and direct-voltage ripple reduction.

5. A method for constructing a power supply for an actuator system, wherein the circuit is successively constructed from:
a first block for connection to the mains, with a capacitor for noise reduction,
a second block with a rectifier circuit,
a third block consisting of a capacitor for noise reduction and direct-voltage ripple reduction, followed by
a fourth block with the common-mode filter, and
a fifth block having a switch-mode converter for regulating a direct voltage.

6. An actuator system comprising at least one linear actuator, a controller, and an operating unit, characterized in that the actuator system comprises a power supply according to claim 1.

7. A power supply for an actuator system comprising:
a rectifying circuit for rectifying and voltage-doubling of an alternating voltage to a direct voltage,
a capacitor applied across the output voltage from the rectifier circuit for smoothing the voltage,
a common-mode filter for reducing common-mode noise, and
a switch-mode converter for regulating a direct voltage,
characterized in that
the common-mode filter is inserted into the power supply downstream of the rectifier circuit and capacitor, and upstream of the switch-mode converter.

8. An actuator system comprising at least one linear actuator, a controller, and an operating unit, characterized in that the actuator system comprises a power supply according to claim 2.

9. An actuator system comprising at least one linear actuator, a controller, and an operating unit, characterized in that the actuator system comprises a power supply according to claim 3.

10. An actuator system comprising at least one linear actuator, a controller, and an operating unit, characterized in that the actuator system comprises a power supply according to claim 4.
